(19) United States
(12) Patent Application Publication
(10) Pub. No.: US 2020/0056590 A1
(43) Pub. Date: Feb. 20, 2020

(54) WIND POWER PLANT DATA INFRASTRUCTURE

(71) Applicant: VESTAS WIND SYSTEMS A/S, Aarhus N (DK)

(72) Inventor: Mehran NOURBAKHSH, Lystrup (DK)

(21) Appl. No.: 16/609,948

(22) PCT Filed: Apr. 23, 2018
(86) PCT No.: PCT/DK2018/050076

§ 371 Date: Oct. 31, 2019

(30) Foreign Application Priority Data
May 5, 2017 (PA) 2017 70313

(51) Int. Cl. F03D 7/04; G05B 19/418

(52) U.S. Cl. CPC F03D 7/047; G05B 2219/24215; G05B 2219/2619; G05B 19/4185

(57) ABSTRACT

A wind power plant data infrastructure (1) comprising two or more assets (2, 3, 4, 5, 6, 7) and a communication system (8) interconnecting the assets (2, 3, 4, 5, 6, 7) is disclosed. At least some of the assets (2, 3, 4, 5, 6, 7) are configured to generate measurement data, and at least some of the assets (2, 3, 4, 5, 6, 7) require measurement data generated by one or more other assets (2, 3, 4, 5, 6, 7). The assets (2, 3, 4, 5, 6, 7) are configured to make measurement data available to the other assets (2, 3, 4, 5, 6, 7), via the communication system (8), and to retrieve measurement data from the other assets (2, 3, 4, 5, 6, 7), via the communication system (8).

### FIELD OF THE INVENTION

The present invention relates to a wind power plant data infrastructure comprising two or more assets and a communication system interconnecting the assets. The invention further relates to a method for sharing measurement data in such a wind power plant data infrastructure.

### BACKGROUND OF THE INVENTION

In a wind power plant, i.e. an entity comprising a plurality of wind turbines arranged within a geographical site, control data relating to the site is required in order to properly control the wind turbines of the wind power plant. To this end the individual wind turbines may measure relevant control data themselves, e.g. in the form of wind speed, wind direction, ambient temperature, humidity, power production, loads on various components, temperatures at various positions inside the wind turbine, etc. Furthermore, the wind turbines may receive further measured data, such as weather data measured by means of a met station arranged at the site or in the vicinity of the site, or weather data measured by means of a satellite.

Data measured by the wind turbines may be supplied to a central data system, such as a Supervisory Control and Data Acquisition (SCADA) system. The SCADA system may analyse the received data, e.g. in order to perform diagnostics on the wind power plant, in order to improve control of the wind power plant, or in order to gain general knowledge regarding the operation of the wind power plant. The SCADA system may also provide data received from one wind turbine to other wind turbines. Thus, in this case the wind turbines may receive control data from each other, but the communication of such data takes place via the SCADA system, in a ‘peer-to-peer’ communication between the SCADA system and the individual wind turbine. No direct mutual exchange of data between the wind turbines takes place.

EP 2 631 471 A1 discloses a wind park comprising at least one wind turbine of a first type comprising a wind parameter measuring system, and at least one wind turbine of a second type which does not comprise a wind parameter measuring system. A data-sharing arrangement provides a wind turbine of the second type with wind-related parameters derived from wind-related parameters collected by a wind turbine of the first type. Mutual direct sharing of data between the wind turbines does not take place.

### DESCRIPTION OF THE INVENTION

It is an object of embodiments of the invention to provide a wind power plant data infrastructure which allows for direct and mutual exchange of data among assets of the wind power plant data infrastructure.

It is a further object of embodiments of the invention to provide a wind power plant data infrastructure which allows measurement data from assets of the wind power plant to be readily available and accessible for other assets of the wind power plant.

According to a first aspect the invention provides a wind power plant data infrastructure comprising:
two or more assets, at least some of the assets being configured to generate measurement data, and at least some of the assets requiring measurement data generated by one or more other assets,
a communication system interconnecting the assets, the assets being configured to make measurement data available to the other assets, via the communication system, and the assets being configured to retrieve measurement data from the other assets, via the communication system.

In the present context the term ‘wind power plant data infrastructure’ should be interpreted to mean an infrastructure which allows data, such as measurement data, to be distributed among various assets of a wind power plant. In the present context the term ‘wind power plant’ should be interpreted to mean a group of wind turbines arranged within a specified geographical site, and sharing some infrastructure, such as access roads, power transmission lines to a power grid, etc. Other components may also form part of the wind power plant, e.g. met stations, grid stations, power plant control units, etc.

The wind power plant data infrastructure according to the first aspect of the invention comprises two or more assets. At least some of the assets are configured to generate measurement data, and at least some of the assets require measurement data generated by one or more other assets. The assets could, e.g., include wind turbines, met stations, grid stations, power plant controllers and/or any other suitable kind of asset which is able to generate measurement data and/or which require measurement data from other assets. The assets being configured to generate measurement data may in addition require measurement data generated by one or more other assets. This would, e.g., allow a given asset to be controlled on the basis of the measurement data generated by the asset itself, as well as on the basis of measurement data received from one or more other assets. This allows the asset to be controlled in a more accurate manner, because a more complete set of control data is available. This may, in turn, result in the performance of the asset being improved.

However, it is not ruled out that at some of the assets are only configured to generate measurement data, but not for receiving data from other assets and/or that some of the assets are not configured to generate measurement data, but only receives data from other assets.

The wind power plant data infrastructure further includes a communication system interconnecting the assets. Thus, each of the assets is in direct communication contact with each of the other assets, via the communication system. Accordingly, the assets are configured to make measurement data available to the other assets, via the communication system, and the assets are configured to retrieve measurement data from the other assets, via the communication system.

Thus, each of the assets being configured to generate measurement data makes data available, and each of the assets which require measurement data generated by other assets can simply retrieve relevant data directly from relevant assets, via the communication system. Thereby the communication system allows direct exchange of measurement data among the assets in a simple and efficient manner, and the communication need not take place via a central data storage, such as a SCADA system or the like.

The two or more assets may include a plurality of wind turbines, each being configured to generate measurement data, and each being configured to retrieve measurement data from the other assets, via the communication system. According to this embodiment, the measurement data generated by the wind turbines can be readily and easily shared among the wind turbines, via the communication system, i.e. a direct and mutual exchange of measurement data can take place between the wind turbines.

The communication system may be or comprise a data bus.

At least one of the assets may be a wind turbine being configured to generate measurement data in the form of measured control parameters. In the present context the term ‘control parameter’ should be interpreted to mean a parameter which is used as a basis for controlling operation of the wind turbine. The control parameters could, e.g., include local measurements of wind speed, wind direction, humidity, ambient temperature, etc.; loads on various wind turbine components, such as wind turbine blades, tower, gear system, rotor, main shaft, etc.; temperatures at various positions in the wind turbine, such as in the generator, in the gear system, lubricant, cooling fluids, etc.; power production of the wind turbine; and/or any other suitable control parameter.

The measured control parameters are typically used ‘locally’ during control of the wind turbine which measures the control parameters. However, the measured control parameters may further be made available to each of the other assets of the wind power plant, via the communication system.

Alternatively or additionally, at least one of the assets may be a met station, a grid station or a power plant controller.

In the present context the term ‘met station’ should be interpreted to mean a station, typically in the form of a mast, having a number of relevant sensors mounted thereon for measuring meteorological data, such as wind speed, wind direction, temperature, humidity, pressure, precipitation, etc. The met station may be arranged at the site of the wind power plant, such as among the wind turbines of the wind power plant, or in the vicinity of this site. Thereby the meteorological data measured by the met station will also be relevant to the wind turbines of the wind power plant, and it is therefore appropriate that the met station makes such data available to other assets, including the wind turbines of the wind power plant, via the communication system, thereby allowing the other assets to directly retrieve relevant data from the met station.

A met station is an example of an asset which is configured to generate measurement data, but which does not require measurement data generated by other assets.

In the present context the term ‘grid station’ should be interpreted to mean a station which measures input and output of power of the wind power plant. The grid station may provide measurement data in the form of active and/or reactive power at the wind power plant.

In the present context the term ‘power plant controller’ should be interpreted to mean a control unit which is configured to control operation of at least a part of the wind power plant, e.g. in order to obtain a stable power supply from the wind power plant to a power grid. A power plant controller may, thus, require measurement data generated by other assets of the wind power plant, including measurement data generated by at least some of the wind turbines of the wind power plant. However, the power plant controller is not necessarily configured to generate measurement data.

Access to measurement data from one asset by another asset may be subject to a set of data access policy rules. In some cases it may not be desirable to make all data measured by an asset, such as a wind turbine, available to the other assets of a wind power plant. For instance, the wind power plant may comprise assets owned by different owners, and/or wind turbines provided by different manufacturers. While it may be desirable to make measurement data relating to weather conditions available to other assets, it may not be desirable to make detailed logging of load data available to other manufacturers. Furthermore, it may be envisaged that certain types of measurement data is not considered relevant for other assets than the one generating the measurement data. Therefore a set of data access policy rules may be defined, which specifies which measurement data a given asset should make available to the other assets, via the communication system, and which measurement data should not be made available. Thereby only relevant measurement data and measurement data which it is desirable to share will be made available.

The set of data access policy rules for a given asset may be defined for that asset by an owner of the asset. According to this embodiment, the owner of the asset determines which data to make available and which not to make available. As an alternative, the set of data access policy rules may be defined by another entity, for instance a manufacturer of the asset.

At least one of the assets may be configured to transmit control commands to at least one of the other assets, via the communication system. According to this embodiment, at least one of the assets may further transmit control commands directly to one or more of the other assets, thereby at least partly controlling the other asset(s). The control commands could, e.g., be generated on the basis of measurement data being available to the asset transmitting the control commands. Examples of such control commands could be a ‘pause’ command, causing a wind turbine to pause operation, a ‘start’ command, causing a wind turbine to start operation, a ‘set power setpoint’ command, causing a power production setpoint of a wind turbine to be set or adjusted, or a ‘restart’ command, causing a SCADA system or the like to restart.

According to a second aspect the invention provides a method for sharing measurement data in a wind power plant data infrastructure comprising two or more assets and a communication system interconnecting the assets, the method comprising the steps of:
at least one of the assets generating measurement data and making the measurement data available to the other assets, via the communication system, and
at least one of the assets retrieving measurement data directly from at least one of the other assets, via the communication system.

It should be noted that a person skilled in the art would readily recognise that any feature described in combination with the first aspect could also be combined with the second aspect, and vice versa.

The method according to the second aspect of the invention is a method for sharing measurement data in wind power plant data infrastructure. The wind power plant data infrastructure comprises two or more assets and a communication system interconnecting the assets. Thus, the wind power plant data infrastructure may advantageously be a wind power plant data infrastructure according to the first aspect of the invention, and the remarks set forth above are therefore equally applicable here.

According to the method of the second aspect of the invention, at least one of the assets generates measurement data and makes the measurement data available to the other assets, via the communication system. The generated measurement data could, e.g., be or include control parameters measured by a wind turbine of the wind power plant, in which case the asset is a wind turbine. As an alternative, the generated measurement data could be or include weather data measured by a met station. As another alternative, the measurement data may be or include any other suitable kind of measured data, which might be of relevance to other assets of the wind power plant.

Next, at least one of the assets retrieves measurement data directly from at least one of the other assets, via the communication system. Thus, the assets make measurement data, which could be relevant to other assets, available, and any asset can retrieve measurement data, which is considered relevant, from any of the other assets. The measurement data is retrieved directly from the asset making the data available, rather than being distributed to the assets via a central unit, such as a SCADA system. This is possible because all of the assets are directly interconnected via the communication system.

The assets may perform mutual exchange of measurement data, via the communication system. According to this embodiment, the measurement data generated by the assets is readily and easily shared among the assets, via the communication system, i.e. a direct and mutual exchange of measurement data can take place between the assets.

The method may further comprise the step of the assets selecting measurement data in accordance with a set of data access policy rules, and only the selected measurement data may be made available to the other assets, via the communication system. According to this embodiment, it is selected which of the measurement data generated by a given asset should be made available to the other assets, and which should not. For instance, measurement data which can be assumed to be of relevance to other assets, e.g. with respect to the control of other assets, may be made available, while measurement data which are considered as confidential or irrelevant for other assets are not made available.

The method may further comprise the step of at least one asset being controlled using measurement data retrieved from one of the other assets. According to this embodiment, at least one of the assets applies measurement data which was generated and made available by another asset when controlling the asset. Thereby the control of the asset is performed on a more accurate basis than would be the case if only measurement data generated by the asset itself was applied. This may lead to improved performance of the asset.

The method may further comprise the step of at least one asset transmitting a control command to at least one of the other assets, via the communication system. According to this embodiment, at least one of the assets transmits control commands to one or more other assets, instead of or in addition to making measurement data available via the communication system. The control commands may, e.g., be based on measurement data generated by the asset transmitting the control commands. For instance, a power plant controller may transmit control commands in the form of power setpoint values to the wind turbines of the wind power plant, in order to ensure that a given power production setpoint is reached for the wind power plant.

### BRIEF DESCRIPTION OF THE DRAWINGS

The invention will now be described in further detail with reference to the accompanying drawing in which

FIG. 1 is a diagrammatic view of a wind power plant data infrastructure according to an embodiment of the invention.

### DETAILED DESCRIPTION OF THE DRAWINGS

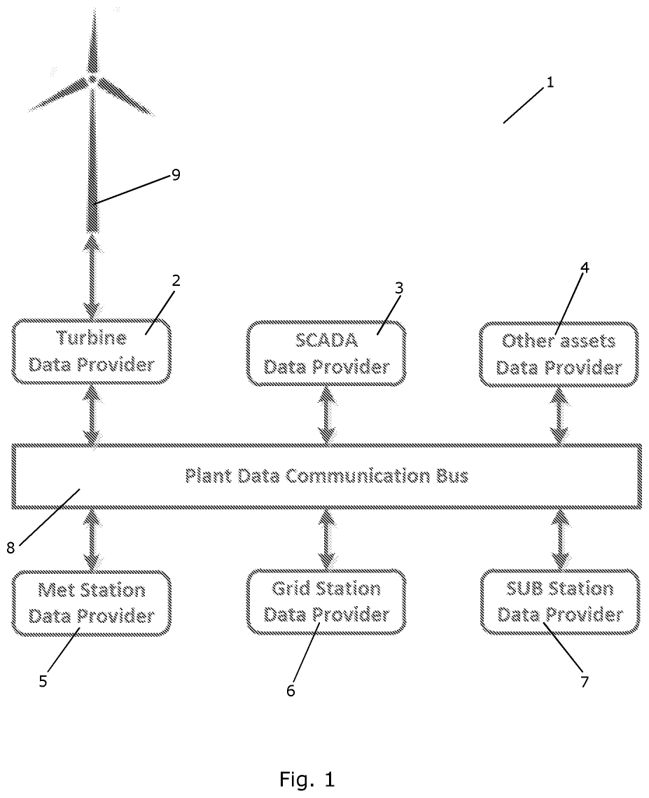

FIG. 1 is a diagrammatic view of a wind power plant data infrastructure 1 according to an embodiment of the invention. The wind power plant data infrastructure 1 comprises a number of assets 2, 3, 4, 5, 6, 7, six of which are shown. The assets 2, 3, 4, 5, 6, 7 are interconnected by a communication system 8 in the form of a plant data communication bus.

A first asset is in the form of a wind turbine data provider 2 associated with a wind turbine 9. Various sensors of the wind turbine 9 measure control parameters which are relevant with respect to control of the wind turbine 9. The control parameters could, e.g., include weather data, such as wind speed, wind direction, humidity, temperature, etc. Furthermore, the control parameters could include loads on various components of the wind turbine 9, temperatures prevailing at various positions inside the wind turbine 9, and/or any other suitable kind of control parameter.

At least some of the measured control parameters are made available to the other assets 3, 4, 5, 6, 7 by the turbine data provider 2, via the communication system 8. Thus, any of the other assets 3, 4, 5, 6, 7 may retrieve relevant measured control parameters directly from the turbine data provider 2, via the communication system 8. This will be described in further detail below. Furthermore, the turbine data provider 2 may retrieve measurement data from one or more of the other assets 3, 4, 5, 6, 7, via the communication system 8. This will also be described in further detail below.

A second asset is in the form of a SCADA data provider 3. SCADA systems are normally used for collecting various kinds of data, and for analysing the collected data. Thus, the SCADA data provider 3 will primarily retrieve measurement data from the other assets 2, 4, 5, 6, 7. However, it is not ruled out that the SCADA data provider 3 makes measurement data available to the other assets 2, 4, 5, 6, 7, via the communication system 8, for instance measurement data obtained from assets which are not connected to the communication system 8, and/or results of analyses performed by the SCADA system.

A third asset is in the form of a data provider 4 from other assets. The other assets could, e.g., be in the form of other wind turbines, third party wind turbines, photovoltaic panels, or any other kind of asset being capable of generating measurement data and/or which require measurement data from other assets.

A fourth asset is in the form of a met station data provider 5. Met stations are normally positioned within or in the vicinity of wind power plants, and are provided with various kinds of sensors for measuring weather data which is considered relevant with respect to control of the wind turbines of the wind power plant. Thus, the met station data provider 5 generates measurement data and makes the data available to the other assets 2, 3, 4, 6, 7, via the communication system 8, but will normally not retrieve measurement data from the other assets 2, 3, 4, 6, 7.

A fifth asset is in the form of a grid station data provider 6. The grid station data provider 6 is a grid meter which measures input and output power from the wind power plant. The grid station data provider 6 may, e.g., make measurement data, in the form of active and/or reactive power at the wind power plant, available via the communication system 8.

A sixth asset is in the form of a SUB station data provider 7. The SUB station data provider 7 could be any third party equipment, such as fire alarms, door alarms, electrical SCADA systems, etc.

Thus, each of the assets 2, 3, 4, 5, 6, 7 may generate measurement data and make the measurement data available to any of the other assets 2, 3, 4, 5, 6, 7, via the communication system 8. Furthermore, each of the assets 2, 3, 4, 5, 6, 7 may retrieve measurement data which is considered relevant for the asset 2, 3, 4, 5, 6, 7 directly from any of the other assets 2, 3, 4, 5, 6, 7, via the communication system 8. Accordingly, the wind power plant data infrastructure 1 allows the assets 2, 3, 4, 5, 6, 7 to mutually exchange relevant measurement data directly with each other, due to the communication system 8 interconnecting the assets 2, 3, 4, 5, 6, 7. Thereby all assets 2, 3, 4, 5, 6, 7 has easy and direct access to a vast amount of relevant measurement data. This may allow the assets 2, 3, 4, 5, 6, 7 to be controlled in a more accurate manner, and the performance of the assets 2, 3, 4, 5, 6, 7 may thereby be improved.

For instance, the turbine data provider 2 may retrieve weather data directly from the met station data provider 5 and relevant analysis results directly from the SCADA data provider 3. The wind turbine 9 may then be controlled on the basis of the retrieved weather data and analysis results, as well as on the basis of control parameters measured directly by the wind turbine 9.

1. A wind power plant data infrastructure comprising:
a plurality of assets, at least a first asset of the plurality of assets being configured to generate measurement data, and at least a second asset of the of the plurality of assets requiring measurement data generated by first assets,
a communication system interconnecting the plurality of assets, the first asset being configured to make measurement data available to the second asset, via the communication system, and the second asset being configured to retrieve measurement data from the first asset, via the communication system.

2. A wind power plant data infrastructure according to claim 1, wherein the plurality of assets include a plurality of wind turbines, each being configured to generate measurement data, and each being configured to retrieve measurement data from the other plurality of wind turbines, via the communication system.

3. A wind power plant data infrastructure according to claim 1, wherein the communication system comprises a data bus.

4. A wind power plant data infrastructure according to claim 1, wherein at least one of the plurality of assets is a wind turbine being configured to generate measurement data in the form of measured control parameters.

5. A wind power plant data infrastructure according to claim 1, wherein at least one of the plurality of assets is a met station, a grid station or a power plant controller.

6. A wind power plant data infrastructure according to claim 1, wherein access to measurement data from the first asset by the second asset is subject to a set of data access policy rules.

7. A wind power plant data infrastructure according to claim 6, wherein the set of data access policy rules for a given asset is defined for that asset by an owner of the asset.

8. A wind power plant data infrastructure according to claim 1, wherein at least one of the plurality of assets is configured to transmit control commands to at least one of the other assets, via the communication system.

9. A method for sharing measurement data in a wind power plant data infrastructure comprising a plurality of assets and a communication system interconnecting the assets, the method comprising:
a first asset of the plurality assets generating measurement data and making the measurement data available to the other assets, via the communication system, and
at least one of the other assets retrieving the measurement data directly from the first asset, via the communication system.

10. A method according to claim 9, wherein the plurality of assets perform mutual exchange of measurement data, via the communication system.

11. A method according to claim 9, further comprising selecting, by one or more of the plurality of assets, measurement data in accordance with a set of data access policy rules, and wherein only the selected measurement data is made available to the other assets, via the communication system.

12. A method according to claim 9, further comprising controlling at least one asset using measurement data retrieved from one of the other assets.

13. A method according to claim 9, further comprising at least one asset transmitting a control command to at least one of the other assets, via the communication system.
